(19) United States
(12) Patent Application Publication
(10) Pub. No.: US 2025/0128614 A1
(43) Pub. Date: Apr. 24, 2025

(54) POWER SUPPLY DEVICE

(71) Applicant: TOYOTA JIDOSHA KABUSHIKI KAISHA, Toyota-shi (JP)

(72) Inventor: Takayoshi TANAKA, Shizuoka-shi (JP)

(73) Assignee: TOYOTA JIDOSHA KABUSHIKI KAISHA, Toyota-shi (JP)

(21) Appl. No.: 18/764,737

(22) Filed: Jul. 5, 2024

(30) Foreign Application Priority Data
Oct. 19, 2023 (JP) 2023-180448

(51) Int. Cl. B60L 53/14; B60L 50/60; H01M 10/42; H01M 50/51; H01M 50/512; H02J 7/00

(52) U.S. Cl. CPC B60L 53/14; B60L 50/60; H01M 10/425; H01M 50/51; H01M 50/512; H02J 7/0013; H01M 2220/20

(57) ABSTRACT

The power supply device includes: a first battery module and a second battery module that can be charged by an external power source; a series circuit in which the first battery module and the second battery module are connected in series; a connection circuit that selectively forms a parallel circuit in which the first battery module and the second battery module are connected in parallel; a variable resistor provided in the connection circuit and interposed between the first battery module and the second battery module in the parallel circuit; and a control device that controls the resistance values of the opening and closing of the plurality of relays and the variable resistor. The control device is configured to be capable of performing a current adjustment process of continuously or stepwise lowering the resistance value of the variable resistor after the parallel circuit is formed by controlling the plurality of relays.

### CROSS-REFERENCE TO RELATED APPLICATION

This application claims priority to Japanese Patent Application No. 2023-180448 filed on Oct. 19, 2023, incorporated herein by reference in its entirety.

### BACKGROUND

### 1. Technical Field

The technology disclosed in the present specification relates to a power supply device.

### 2. Description of Related Art

Japanese Unexamined Patent Application Publication No. 2019-118221 (JP 2019-118221 A) describes a power supply device. The power supply device includes two battery modules that can be charged by an external power supply, and a plurality of relays. The power supply device includes a connection circuit that selectively forms a series circuit in which the two battery modules are connected in series and a parallel circuit in which the two battery modules are connected in parallel, and a control device that controls opening and closing of the relays.

### SUMMARY

In the power supply device as described above, when the two battery modules connected in series are charged and discharged for a long period of time, the state of charge (SOC) may differ between the battery modules. In this case, a voltage difference occurs between the two battery modules. Therefore, when the battery modules are connected in parallel, a circulation current is generated to circulate between the battery modules. Depending on the voltage difference at this time, an arc may be generated at a contact point of the relay or an excessive circulation current may flow. In order to prevent the generation of an arc and an excessive circulation current, it is necessary to prohibit the parallel connection of the battery modules depending on the voltage difference between the battery modules.

When the parallel connection of the battery modules is frequently prohibited, however, a problem arises, for example, in that the function and convenience of the power supply device are impaired. Therefore, when the two battery modules are connected in parallel, a resistor may be interposed between the two battery modules. Thus, it is possible to suppress the generation of an arc in the relay and reduce the magnitude of the circulation current with respect to the voltage difference between the battery modules, and it is possible to significantly reduce the frequency of prohibition of the parallel connection of the battery modules. By reducing the circulation current with the resistor, a long period is required to eliminate the voltage difference between the battery modules. As a result, the function and convenience of the power supply device are still impaired.

In view of the above trade-off problem, the present specification provides a technology capable of eliminating a voltage difference (also referred to as “difference in state of charge”) between two battery modules in a short period while suppressing the generation of an arc in a relay etc. when the battery modules are connected in parallel.

The technology disclosed in the present specification is embodied as a power supply device. In a first aspect, the power supply device includes:
a first battery module and a second battery module chargeable by an external power supply;
a connection circuit including a plurality of relays and configured to selectively form a series circuit and a parallel circuit;
a variable resistor provided in the connection circuit and interposed between the first battery module and the second battery module in the parallel circuit; and
a control device configured to control opening and closing of the relays and a resistance value of the variable resistor. The series circuit is a circuit in which the first battery module and the second battery module are connected in series. The parallel circuit is a circuit in which the first battery module and the second battery module are connected in parallel. The control device is configured to execute a current adjustment process for reducing the resistance value of the variable resistor continuously or stepwise after controlling the relays to form the parallel circuit. The number of battery modules in the power supply device need not be two, and may be three or more.

In the above configuration, the variable resistor is interposed in the parallel circuit in which the two battery modules are connected in parallel. The resistance value of the variable resistor can be controlled to decrease continuously or stepwise after the parallel circuit is formed. Thus, it is possible to suppress the generation of an arc in the relay and reduce the magnitude of the circulation current by interposing the resistor having a relatively high resistance when the two battery modules are connected in parallel. Therefore, the parallel connection of the battery modules can be allowed and the frequency of prohibition of the parallel connection can be reduced even when the voltage difference between the battery modules is relatively large.

Then, the circulation current flows so that the voltage difference between the battery modules is gradually eliminated, and the circulation current is also reduced. In this case, the voltage difference (or the difference in the state of charge) between the battery modules can be eliminated at an early stage by reducing the resistance value of the variable resistor and relaxing the limit on the circulation current. As the voltage difference between the battery modules decreases, the allowable value of the circulation current for the relays, the battery modules, and the variable resistor increases. Therefore, the resistance value of the variable resistor may greatly be reduced so that the circulation current increases with time.

In the first aspect,
the control device may be configured to:
estimate or detect at least one of an open circuit voltage difference between the first battery module and the second battery module and a circulation current flowing between the first battery module and the second battery module; and
determine the resistance value of the variable resistor based on at least one of the open circuit voltage difference and the circulation current.
The amount of heat generated by the circulation current in the relays, the battery modules, and the variable resistor depends on the voltage difference between the battery modules and the magnitude of the circulation current. Since the voltage difference and the magnitude of the circulation current are correlated, one of them can be estimated from the other. Therefore, the circulation current can appropriately be adjusted by determining the resistance value of the variable resistor based on at least one of the voltage difference and the circulation current.

In the first aspect,
the control device may be configured to
determine the resistance value of the variable resistor to control a product of the open circuit voltage difference and the circulation current to be equal to or smaller than a predetermined threshold value.
More precisely, the amount of heat generated by the circulation current in the relays, the battery modules, and the variable resistor depends on the product of the voltage difference between the battery modules and the magnitude of the circulation current (i.e., electric power). Therefore, the circulation current can be reduced without excess or deficiency by determining the resistance value of the variable resistor so that the product of the voltage difference and the circulation current is equal to or smaller than the threshold value that can be allowed in the relays, the battery modules, and the variable resistor.

In the first aspect,
the connection circuit may include a bypass circuit configured to bypass the variable resistor via at least one of the relays.
In this case, the control device may be configured to
electrically open the bypass circuit during execution of the current adjustment process, and conduct the bypass circuit after completion of the current adjustment process. With such a configuration, the variable resistor is short-circuited by the bypass circuit, for example, after the voltage difference between the battery modules is sufficiently eliminated. Therefore, unnecessary energization of the variable resistor can be avoided.

In the first aspect, the connection circuit may include a system main relay configured to connect and disconnect the first battery module and the second battery module to and from a load. In this case, the variable resistor may be a precharge resistor provided in the system main relay. That is, by adopting the variable resistor as the precharge resistor provided in the system main relay, the precharge resistor can also be used as the above variable resistor in the parallel connection.

In a second aspect, an electrified vehicle may include:
a motor configured to drive a wheel;
the power supply device according to the first aspect that is configured to supply electric power to the motor; and
a charging inlet configured such that the external power supply is attachable to and detachable from the charging inlet.
In this case, the control device may be configured to:
when the power supply device supplies the electric power to the motor, control the connection circuit to form the series circuit to connect the first battery module and the second battery module in series to the motor; and
when the power supply device is charged by the external power supply, control the connection circuit to form the parallel circuit to connect the first battery module and the second battery module in parallel to the charging inlet.
With such a configuration, when the power supply device supplies the electric power to the motor, the first battery module and the second battery module are connected in series. Therefore, the electric power can be supplied at a high voltage. When the power supply device is charged by the external power supply, the first battery module and the second battery module are connected in parallel. Therefore, the output voltage required in the external power supply can be lowered.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of a power supply device 10 according to an embodiment and a vehicle 100 on which the power supply device is mounted;

FIG. 2 is a circuit diagram schematically showing a series circuit formed by the connection circuit 16;

FIG. 3 is a circuit diagram schematically showing a parallel circuit formed by the connection circuit 16;

FIG. 4A shows the change of the resistance value R of the second precharge resistor 44 over time in the current adjusting process;

FIG. 4B is a diagram showing a change with time of a detection value of the charge rate SOC1 of the first battery module 12 and a change with time of a detection value of the charge rate SOC2 of the second battery module 14 in the current adjusting process;

FIG. 4C is a diagram showing a change with time of the open-circuit voltage V1 of the first battery module 12, a change with time of the open-circuit voltage V2 of the second battery module 14, and a change with time of the open-circuit voltage differential dV thereof in the current adjusting process;

FIG. 4D shows the change over time of the circulating current I in the current regulating process;

FIG. 4E shows a product W of the open-circuit voltage difference between the battery modules 12 and 14 and the circulating current in the current adjusting process, and shows a change with time in the calorific value (electric power) caused by the circulating current; and

FIG. 5 shows a modification of the mode in which the resistance value R of the second precharge resistor 44 is changed in the current adjustment process.

### DETAILED DESCRIPTION OF EMBODIMENTS

With reference to the drawings, a power supply device 10 of an embodiment and a vehicle 100 in which the power supply device is employed will be described. The power supply device 10 is a device that supplies electric power to the plurality of motors 102, 104, 106, and 108 of the vehicle 100. The power supply device 10 according to the present embodiment includes a plurality of battery modules 12 and 14, and is sometimes referred to as a battery pack. Each battery module 12, 14 is configured to be rechargeable. Here, the vehicle 100 is an electrified vehicle traveling on a road surface, and is so-called battery electric vehicle (BEV: Battery Electric Vehicle). However, the vehicle 100 is not limited to battery electric vehicle, and may be hybrid electric vehicle (HEV: Hybrid Electric Vehicle), plug-in hybrid electric vehicle (PHEV: Plug-in Hybrid Electric Vehicle), fuel cell electric vehicle (FCEV: Fuel Cell Electric Vehicle). The motors 102, 104, 106, and 108 in the present embodiment are examples of loads mounted on the vehicle 100.

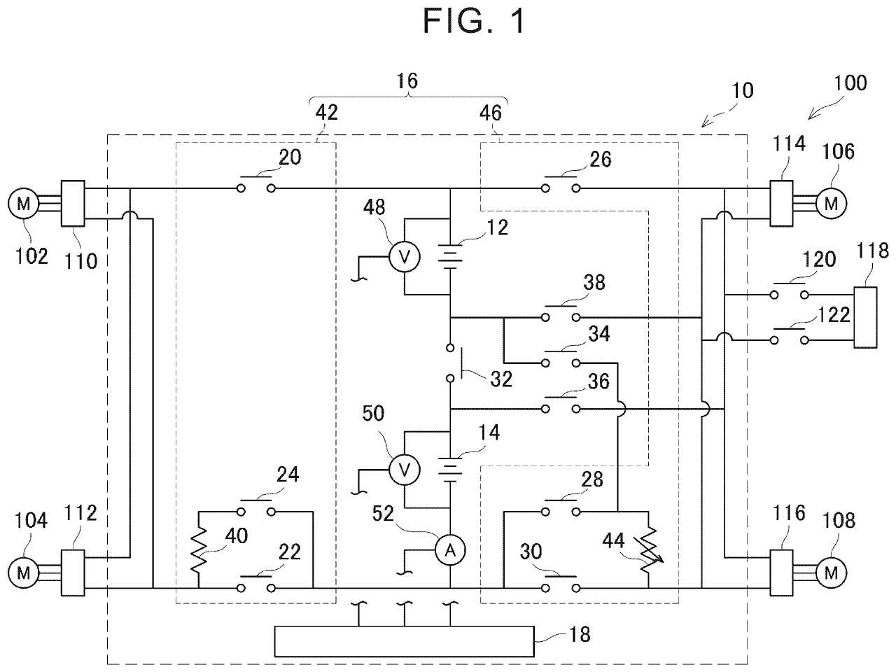

As illustrated in FIG. 1, the vehicle 100 includes a plurality of motors 102, 104, 106, and 108 and a plurality of inverters 110, 112, 114, and 116. Each of the motors 102, 104, 106, and 108 is a driving motor that drives wheels of the vehicle 100. The plurality of motors 102, 104, 106, and 108 includes a first motor 102, a second motor 104, a third motor 106, and a fourth motor 108. The first motor 102 drives the right front wheel, the second motor 104 drives the left front wheel, the third motor 106 drives the right rear wheel, and the fourth motor 108 drives the left rear wheel. Each of the inverters 110, 112, 114, and 116 is a device that performs DC-AC power conversion between the power supply device 10 and the corresponding motor 102, 104, 106, and 108. The plurality of inverters 110, 112, 114, and 116 includes a first inverter 110, a second inverter 112, a third inverter 114, and a fourth inverter 116. The first inverter 110 is provided between the power supply device 10 and the first motor 102, converts the DC power from the power supply device 10 into three-phase AC power, can be supplied to the first motor 102. The first inverter 110 may convert the three-phase AC power from the first motor 102 into DC power and supply the DC power to the power supply device 10. The configurations of the second inverter 112, the third inverter 114, and the fourth inverter 116 are the same as those of the first inverter 110, and thus description thereof will be omitted. Although not particularly limited, when the rated voltage of the power supply device 10 and the rated voltages of the motors 102, 104, 106, and 108 differ from each other, DC-DC converters may be further provided between the power supply device 10 and the inverters 110, 112, 114, and 116.

Note that the motors 102, 104, 106, and 108 do not necessarily need to drive only one wheel. For example, one motor may drive a pair of front or rear wheels. Therefore, the number of motors 102, 104, 106, and 108 included in the vehicle 100 is not limited to four, and may be one or more. In addition, the number of the plurality of inverters 110, 112, 114, and 116 can be appropriately changed according to the number, arrangement, and the like of the plurality of motors 102, 104, 106, and 108.

As shown in FIG. 1, the vehicle 100 further includes a charging inlet 118. The charging inlet 118 is configured to be detachable from an external power source. For example, when the battery modules 12 and 14 of the power supply device 10 mounted on the vehicle 100 are charged, the external power source and the charging inlet 118 of the vehicle 100 are connected via the power supply connector. As a result, the AC power from the external power source is supplied to the battery modules 12 and 14. Thus, the vehicle 100 can charge the battery modules 12, 14 with an external power source. As an example, the external power source is a power source that supplies AC power, such as a commercial power source for household use or a charging station. Although not particularly limited, the charging inlet 118 is connected to the power supply device 10 via the charging relays 120 and 122.

As described above, the power supply device 10 includes the first battery module 12 and the second battery module 14. Each of the battery modules 12 and 14 includes a plurality of battery cells arranged in a stacked manner. Each battery cell is, for example, a rechargeable secondary battery cell such as a lithium ion battery cell, an all-solid-state battery cell, or a nickel metal hydride battery cell. The specific number of the plurality of battery cells is not particularly limited, and can be appropriately changed according to the output voltage required for each of the battery modules 12 and 14. Further, the number of battery modules included in the power supply device 10 is not necessarily two, and may be three or more.

As illustrated in FIG. 1, the power supply device 10 further includes a connection circuit 16 and a control device 18. The connection circuit 16 comprises a plurality of relays 20, 22, 24, 26, 28, 30, 32, 34, 36, 38. The control device 18 controls the opening and closing of the plurality of relays 20 to 38.

The plurality of relays 20-38 includes a first relay 20, a second relay 22, and a third relay 24. These relays 20, 22, and 24 together with the first precharge resistor 40 constitute the first system main relay 42. The third relay 24 and the first precharge resistor 40 are connected in series, and they are connected in parallel to the second relay 22. As described above, the first system main relay 42 is provided with the first precharge resistor 40 for avoiding excessive inrush current. The first system main relay 42 is interposed between the battery modules 12 and 14 and the first motor 102, and can electrically connect and disconnect the battery modules 12 and 14 and the first motor 102. The first system main relay 42 is also interposed between the battery modules 12 and 14 and the second motor 104, and can electrically connect and disconnect the battery modules 12 and 14 and the second motor 104. In addition, when the battery modules 12 and 14 are electrically connected to the motors 102 and 104, the first system main relay 42 can avoid excessive inrush current by interposing a precharge resistor 40 therebetween.

The plurality of relays 20-38 further include a fourth relay 26, a fifth relay 28, and a sixth relay 30. These relays 26, 28, 30 together with the second precharge resistor 44 constitute a second system main relay 46. The second precharge resistor 44 is a variable resistor. The resistance value of the second precharge resistor 44 is controlled by the control device 18. The sixth relay 30 and the second precharge resistor 44 are connected in series, and they are connected in parallel to the fifth relay 28. That is, similarly to the first system main relay 42, the second system main relay 46 is also provided with a second precharge resistor 44 for avoiding excessive inrush current. The second system main relay 46 is interposed between the battery modules 12 and 14 and the third motor 106, and can electrically connect and disconnect the battery modules 12 and 14 and the third motor 106. The second system main relay 46 is also interposed between the battery modules 12 and 14 and the fourth motor 108, and can electrically connect and disconnect the battery modules 12 and 14 and the fourth motor 108. In addition, when the battery modules 12 and 14 are electrically connected to the motors 106 and 108, the second system main relay 46 can avoid excessive inrush current by interposing a second precharge resistor 44 therebetween.

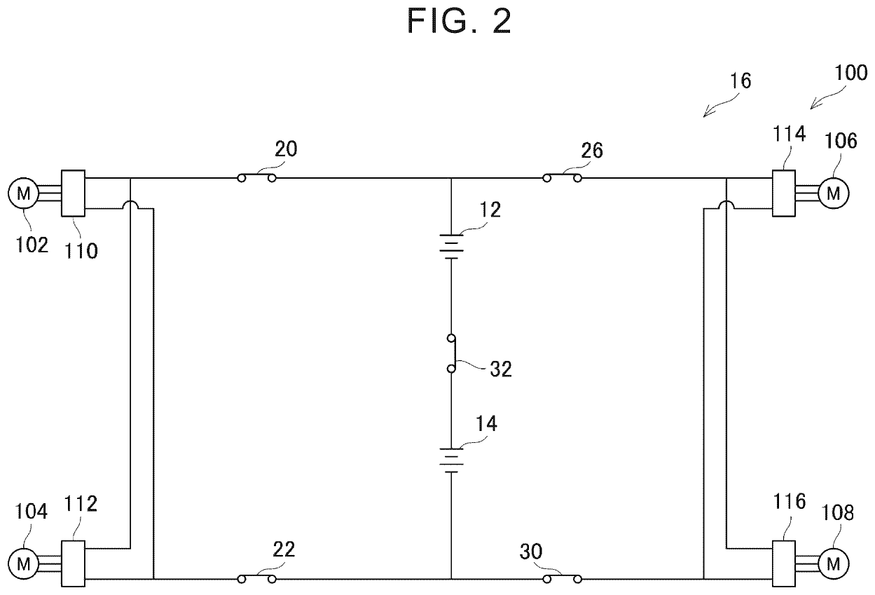

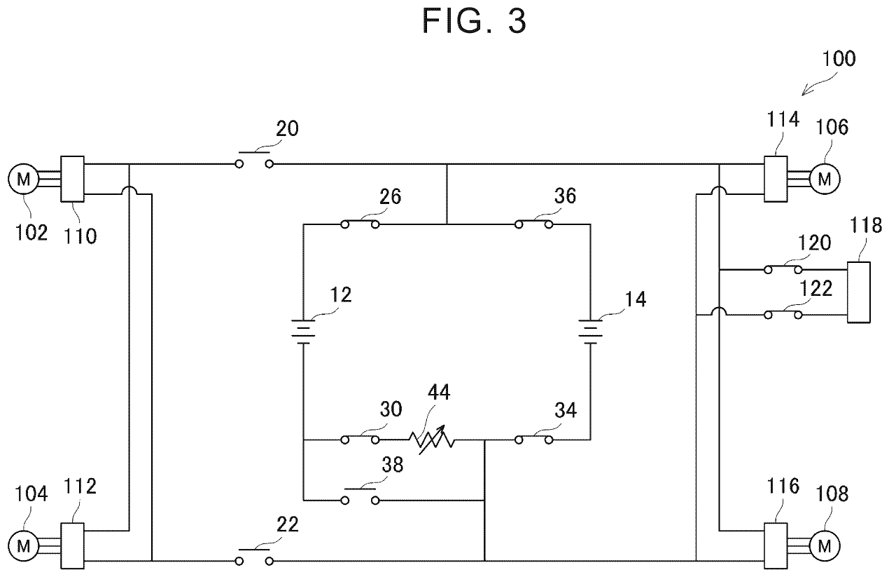

The plurality of relays 20-38 further include a seventh relay 32, an eighth relay 34, a ninth relay 36, and a tenth relay 38. These relays 32, 34, 36, 38 are provided for switching the connection between the first battery module 12 and the second battery module 14. That is, the control device 18 is configured to selectively form the series circuit shown in FIG. 2 and the parallel circuit shown in FIG. 3 in the connection circuit 16 by controlling the opening and closing of the plurality of relays 20-38. Specifically, when the control device 18 closes the relays 20, 22, 26, 30, 32 and opens the other relays, the connection circuit 16 forms the series circuit shown in FIG. 2. In this series circuit, the first battery module 12 and the second battery module 14 are connected in series. Further, the first battery module 12 and the second battery module 14 connected in series are electrically connected to four inverters 110, 112, 114, and 116 and four motors 102, 104, 106, and 108.

On the other hand, when the control device 18 closes the relays 26, 30, 34, and 36 and opens the other relays, the connection circuit 16 forms the parallel circuit shown in FIG. 3. In this parallel circuit, the first battery module 12 and the second battery module 14 are connected in parallel. Further, the first battery module 12 and the second battery module 14 connected in parallel are electrically connected to the charging inlet 118 via the charging relays 120 and 122. Thus, when the external power source is connected to the charging inlet 118 via the power supply connector, the two battery modules 12 and 14 can be charged by the external power source. Further, in the parallel circuit shown in FIG. 3, the second precharge resistor 44 is interposed between the first battery module 12 and the second battery module 14. As described above, the second precharge resistor 44 is a variable resistor, and the resistance value of the second precharge resistor 44 is controlled by the control device 18.

The control device 18 monitors the charge rate (State of Charge: SOC) of the first battery module 12 and the charge rate of the second battery module 14, respectively. The method is not particularly limited. For example, the control device 18 may calculate the charging rate of the first battery module 12 by integrating the charging current and the discharging current of the first battery module 12 over time. The same applies to the second battery module 14. The control device 18 estimates the open circuit voltage of the first battery module 12 based on the charging rate of the first battery module 12, and estimates the open circuit voltage of the second battery module 14 based on the charging rate of the second battery module 14. Then, the control device 18 estimates the open circuit voltage difference between the first battery module 12 and the second battery module 14 by using the two open circuit voltages. The control device 18 uses the two open-circuit voltages to estimate the circulating current flowing between the first battery module 12 and the second battery module 14 in the parallel circuit (see FIG. 3). The resistance values of the entire parallel circuit (that is, the internal resistance values of the battery modules 12 and 14, the resistance value of the second precharge resistor 44, and the resistance values of other circuit components) are known. Therefore, the circulating current can be obtained by dividing the open-circuit voltage difference by the resistance value.

As shown in FIG. 1, the open circuit voltage of the first battery module 12, the open circuit voltage of the second battery module 14, and the circulating current between the two battery modules 12 and 14 may be directly detected by the voltage sensors 48 and 58 and the current sensor 52, or may be estimated from the detected values. Alternatively, the control device 18 may use these sensors 48, 50, 52 to calculate the charge rate described above.

With the above configuration, when the vehicle 100 travels, the power supply device 10 is electrically connected to the motors 102, 104, 106, and 108. In this case, the control device 18 causes the connection circuit 16 to constitute the series circuit shown in FIG. 2. As a result, the first battery module 12 and the second battery module 14 are connected in series to the plurality of motors 102, 104, 106, and 108. Accordingly, the power supply device 10 can supply power to the plurality of motors 102, 104, 106, and 108 at a relatively high voltage. On the other hand, when the power supply device 10 is charged by an external power supply, the power supply device 10 is electrically connected to the charging inlet 118. In this case, the control device 18 causes the connection circuit 16 to constitute the parallel circuit shown in FIG. 3. As a result, the first battery module 12 and the second battery module 14 are connected in parallel to the charging inlet 118. Accordingly, the power supply device 10 can be charged with a relatively low charging voltage, and the output voltage required for the external power supply can be lowered.

As described above, in the power supply device 10 of the present embodiment, the connection mode of the two battery modules 12 and 14 can be switched between the series connection and the parallel connection. However, when two battery modules 12 and 14 connected in series are charged and discharged for a long period of time, a difference in charge rate may occur between the battery modules 12 and 14. In this case, an open-circuit voltage difference (hereinafter, simply referred to as a voltage difference) is generated between the two battery modules 12 and 14, and therefore, when the battery modules 12 and 14 are connected in parallel, a circulating current in which a current circulates between the battery modules 12 and 14 is generated. At this time, depending on the voltage difference, an arc may be generated at the contact point of the relays 20-38, or an excessive circulation current may flow. Therefore, the control device 18 is configured to prohibit the parallel connection of the battery modules 12 and 14 in accordance with the voltage difference between the two battery modules 12 and 14 in order to prevent the occurrence of an arc or an excessive circulating current.

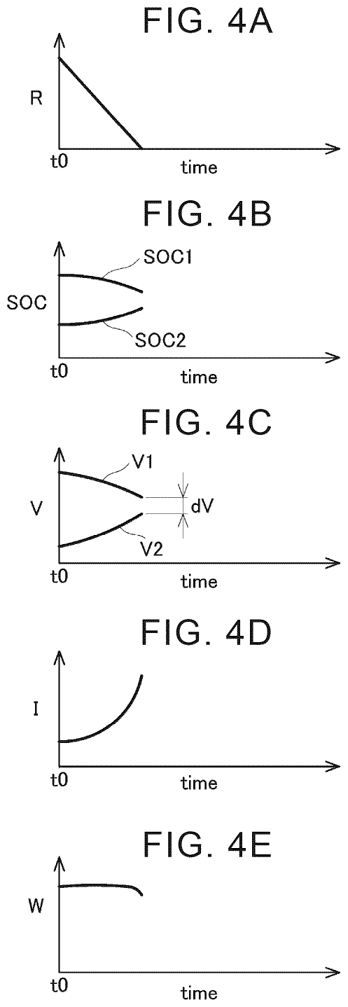

However, when the parallel connection of the battery modules 12 and 14 is frequently prohibited, for example, the function and convenience of the power supply device 10 are impaired. Therefore, in the power supply device 10 of the present embodiment, when the connection circuit 16 forms the parallel circuit shown in FIG. 3, the second precharge resistor 44, which is a variable resistor, is interposed between the two battery modules 12 and 14. As a result, the occurrence of an arc in the relays 20-38 and the magnitude of the circulating current are suppressed with respect to the voltage difference between the battery modules 12 and 14. As a result, the frequency at which the parallel connection of the battery modules 12, 14 is prohibited is significantly reduced. In addition, the control device 18 is configured to control the plurality of relays 20-38 to form a parallel circuit, and then execute the current adjustment process shown in FIG. 4A to FIG. 4E. As shown in FIG. 4A, in the current adjusting process, the control device 18 continuously lowers the resistance value (R) of the second precharge resistor 44. This avoids excessive limitations on the circulating current (I). Consequently, as shown in FIG. 4B and FIG. 4C, the difference in the charge rate (SOC1, SOC2) between the battery modules 12 and 14 and the voltage difference (dV) between the battery modules 12 and 14 are eliminated at an early stage.

That is, at the time point to when the two battery modules 12 and 14 are connected in parallel, the difference in charge rate between the battery modules 12 and 14 and the difference in voltage between the battery modules 12 and 14 are relatively large. On the other hand, the resistance value of the second precharge resistor 44 is set to be relatively high. Therefore, as shown in FIG. 4D, the magnitude of the circulating current is suppressed, and the generation of arcing in the relays 20-38 is also suppressed.

Thereafter, as the circulating current flows, as shown in FIG. 4B and FIG. 4C, the difference in charge rate and the difference in charge rate between the battery modules 12 and 14 are gradually eliminated. In parallel with this, the resistance value of the second precharge resistor 44 continuously decreases. By reducing the limit on the circulating current, the voltage difference between the battery modules 12 and 14 is eliminated at an early stage. Note that as the voltage difference between the battery modules 12 and 14 decreases, the allowable value of the circulating current for the relays 20-38, the battery modules 12 and 14, and the second precharge resistor 44 increases. Therefore, as shown in FIG. 4D, the resistance value of the second precharge resistor 44 may be greatly reduced so that the circulating current increases with time.

As an example, as shown in FIG. 4E, the control device 18 of the present embodiment determines the resistance value of the second precharge resistor 44 such that the product (W) of the voltage-difference and the circulating current is equal to or less than a predetermined threshold. The amount of heat generated by the circulation current of the relays 20-38, the battery modules 12 and 14, and the second precharge resistor 44 depends on the product of the voltage difference between the battery modules 12 and 14 and the magnitude of the circulation current (i.e., power). Therefore, by determining the resistance value of the second precharge resistor 44 so that the product (W) of the voltage difference and the circulation current is equal to or less than the threshold value that the relays 20 to 38, the battery modules 12 and 14, and the second precharge resistor 44 can allow, the circulation current can be suppressed without excess or deficiency.

In another embodiment, the control device 18 may determine the resistance value of the second precharge resistor 44 based on at least one of the voltage difference and the circulating current. The amount of heat generated by the circulation currents of the relays 20 to 38, the battery modules 12 and 14, and the second precharge resistor 44 depends on the voltage difference between the battery modules 12 and 14 and the magnitude of the circulation current. Since the magnitude of the voltage difference and the circulating current are correlated, the other can be estimated from one of them. Therefore, the circulation current can be appropriately adjusted by determining the resistance value of the second precharge resistor 44 based on at least one of the voltage difference and the circulation current.

As yet another embodiment, the resistance value of the second precharge resistor 44 may be set in advance based on the allowable value of the heat generation amount due to the circulation current of the relays 20-38, the battery modules 12 and 14, and the second precharge resistor 44.

In the parallel circuit shown in FIG. 3, when the control device 18 closes the tenth relay 38 and opens the sixth relay 30, the second precharge resistor 44 is bypassed. Thus, the connection circuit 16 can connect the two battery modules 12 and 14 in parallel while bypassing the second precharge resistor 44. That is, the connection circuit 16 includes a bypass circuit that bypasses the second precharge resistor 44 via the tenth relay 38. As an example, the control device 18 of the present embodiment electrically opens the bypass circuit during the execution of the current adjustment process, and conducts the bypass circuit after the completion of the current adjustment process. Specifically, the control device 18 closes the sixth relay 30 and opens the tenth relay 38 to interpose the second precharge resistor 44 between the two battery modules 12 and 14 during the current adjustment process. After the current adjustment process is completed, the control device 18 closes the tenth relay 38 and opens the sixth relay 30 to bypass the second precharge resistor 44. According to such a configuration, for example, after the voltage difference between the battery modules 12 and 14 falls below a predetermined value and the voltage difference between the battery modules 12 and 14 is sufficiently eliminated, the second precharge resistor 44 can be short-circuited by the bypass circuit. Therefore, unnecessary energization of the second precharge resistor 44 can be avoided.

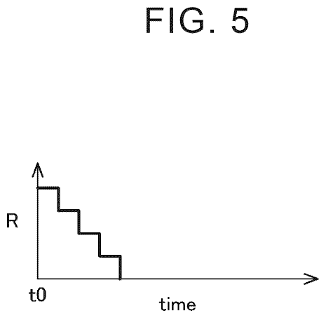

As shown in FIG. 4A, the control device 18 of the present embodiment performs a current adjustment process of continuously decreasing the resistance value of the second precharge resistor 44 in the current adjustment process. In another embodiment, as shown in FIG. 5, the control device 18 may gradually reduce the resistance value of the second precharge resistor 44 in the current adjustment process. Even in such a configuration, when the two battery modules 12 and 14 are connected in parallel, it is possible to eliminate the voltage difference between the battery modules 12 and 14 in a short time while suppressing the occurrence of arcs in the relays 20 to 38 and the like.

Although a number of specific examples have been described in detail above, these are merely examples and do not limit the scope of claims. The techniques described in the claims include various modifications and alterations of the specific examples illustrated above. The technical elements described in the present specification or drawings exhibit technical utility either on its own or in combination.

What is claimed is:

1. A power supply device comprising:
a first battery module and a second battery module chargeable by an external power supply;
a connection circuit including a plurality of relays and configured to selectively form a series circuit and a parallel circuit, the series circuit being a circuit in which the first battery module and the second battery module are connected in series, and the parallel circuit being a circuit in which the first battery module and the second battery module are connected in parallel;
a variable resistor provided in the connection circuit and interposed between the first battery module and the second battery module in the parallel circuit; and
a control device configured to control opening and closing of the relays and a resistance value of the variable resistor, wherein the control device is configured to execute a current adjustment process for reducing the resistance value of the variable resistor continuously or stepwise after controlling the relays to form the parallel circuit.

2. The power supply device according to claim 1, wherein the control device is configured to:
estimate or detect at least one of an open circuit voltage difference between the first battery module and the second battery module and a circulation current flowing between the first battery module and the second battery module; and
determine the resistance value of the variable resistor based on at least one of the open circuit voltage difference and the circulation current.

3. The power supply device according to claim 2, wherein the control device is configured to determine the resistance value of the variable resistor to control a product of the open circuit voltage difference and the circulation current to be equal to or smaller than a predetermined threshold value.

4. The power supply device according to claim 1, wherein:
the connection circuit includes a bypass circuit configured to bypass the variable resistor via at least one of the relays; and
the control device is configured to electrically open the bypass circuit during execution of the current adjustment process, and conduct the bypass circuit after completion of the current adjustment process.

5. An electrified vehicle comprising:
a motor configured to drive a wheel;
the power supply device according to claim 1 that is configured to supply electric power to the motor; and
a charging inlet configured such that the external power supply is attachable to and detachable from the charging inlet, wherein the control device is configured to:
when the power supply device supplies the electric power to the motor, control the connection circuit to form the series circuit to connect the first battery module and the second battery module in series to the motor; and
when the power supply device is charged by the external power supply, control the connection circuit to form the parallel circuit to connect the first battery module and the second battery module in parallel to the charging inlet.
